(19) United States
(12) Patent Application Publication
(10) Pub. No.: US 2008/0025162 A1
(43) Pub. Date: Jan. 31, 2008

(54) OPTICAL DISK APPARATUS AND PICKUP POSITIONING METHOD

(76) Inventor: Hiroshi NAKANE, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/773,596

(22) Filed: Jul. 5, 2007

(30) Foreign Application Priority Data
Jul. 25, 2006 (JP) 2006-202233

(51) Int. Cl. G11B 7/00

(52) U.S. Cl. 369/44.14

(57) ABSTRACT

An optical disk apparatus includes an optical pickup head which detects a signal corresponding to data recorded on an optical disk, a stepping motor which includes a stator and a rotor, and excites the stator to rotate the rotor, thereby radially moving the optical pickup head over the optical disk, a stopper which limits a range of movement of the pickup head when the pickup head is brought into contact with the stopper by the stepping motor, and a controller which controls, when the optical pickup head is brought into contact with the stopper and positioned at an initial position, the stepping motor by setting the stator at an electric angle corresponding to a rotation angle of the rotor assumed when the optical pickup head is in contact with the stopper.

### CROSS-REFERENCE TO RELATED APPLICATIONS

This application is based upon and claims the benefit of priority from prior Japanese Patent Application No. 2006-202233, filed Jul. 25, 2006, the entire contents of which are incorporated herein by reference.

### BACKGROUND OF THE INVENTION

1. Field of the Invention

The present invention relates to an optical disk apparatus with a stepping motor for moving a pickup head in the radial direction of an optical disk, and a pickup positioning method employed in the apparatus.

2. Description of the Related Art

In recent years, in optical disk apparatuses, the use of stepping motors as feed motors for moving a pickup head in the radial direction of an optical disk has become mainstream. General optical disk apparatuses employ stepping motors simple in structure and using magnets as rotors. The stepping motors are excited by, for example, a two-phase excitation scheme. Since this structure is brushless, it wears well and exhibits high positioning accuracy.

However, stepping motors are synchronous motors, therefore their positioning accuracy is reduced and great vibration occurs when they are out of step. To avoid the step-out state, they consume much power. Further, since the rotation and electric angles of the rotor and stator cannot be detected, it is necessary to synchronize the rotor with the stator at the start of driving them.

Upon power on, the stator is excited and synchronized with the rotor. After that, the pickup head is radially inwardly moved over an optical disk. Until the pickup head is brought into contact with a mechanical inner-periphery detection switch, the stepping motor is driven. When the switch detects that the pickup head has reached a preset position on the optical disk, the excitation of the stator is stopped. Since the switch has a weak pressure, the synchronous state of the stator and rotor is maintained even if the pickup head contacts the switch.

In conventional optical disk apparatuses, the position of the pickup head is controlled using the inner-periphery detection switch in the following manner:

Jpn. Pat. Appln. KOKAI Publication No. 2000-251270, for example, discloses an optical disk apparatus that employs an innermost-periphery detection switch for detecting whether an optical pickup head is positioned at the innermost periphery of an optical disk. Referring to the position detected by the switch, the movement of the optical pickup head is controlled using a driving signal supplied to a thread motor. In this apparatus, the reference point for the optical pickup head is determined by only once bringing the optical pickup head into contact with the innermost-periphery detection switch during initialization.

Jpn. Pat. Appln. KOKAI Publication No. 2003-141750 discloses an optical disk apparatus, in which an optical pickup head moving radially inwardly over an optical disk is detected using a position detection switch and control circuit. In this optical disk apparatus, information indicating the distance between the position detection switch and a controlled track region on the optical disk is stored in a nonvolatile memory incorporated in the control circuit. When moving the optical head to the controlled track region on the optical disk, the position of the optical head is detected by the position detection switch, and then the distance information stored in the nonvolatile memory of the control circuit is used to move the optical head.

Jpn. Pat. Appln. KOKAI Publication No. 08-55446 discloses an optical disk apparatus, in which when an optical head executes a rough search for reading, from disk data, an absolute time that indicates the position of a optical disk, an origin position detector detects the position of the optical pickup head. In this optical disk apparatus, when the origin position detector has detected the position of the optical pickup head, based on the disk data, the distance between the optical pickup head and a target track position is computed. Based on the distance from the target track position, the number of pulses to be output to a stepping motor is computed, thereby controlling the stepping motor to perform position control of the optical pickup head, based on the computation result.

As described above, the conventional optical disk apparatuses employ detection switches for detecting the initial position of the optical pickup head. However, the detection switches are of contact type, and hence do not have high durability. If the detection switches are made noncontact to enhance durability, this costs high. On the other hand, if no detection switches are employed, the position of the pickup head cannot be detected accurately.

### BRIEF SUMMARY OF THE INVENTION

According to an aspect of the present invention, there is provided an optical disk apparatus comprising: an optical pickup head which detects a signal corresponding to data recorded on an optical disk; a stepping motor which includes a stator and a rotor, and excites the stator to rotate the rotor, thereby radially moving the optical pickup head over the optical disk; a stopper which limits a range of movement of the optical pickup head when the optical pickup head is brought into contact with the stopper by the stepping motor; and a controller which controls, when the optical pickup head is brought into contact with the stopper and positioned at an initial position, the stepping motor by setting the stator at an electric angle corresponding to a rotation angle of the rotor assumed when the optical pickup head is in contact with the stopper.

According to another aspect of the invention, there is provided a optical pickup head positioning method for use in an optical disk apparatus including an optical pickup head which detects a signal corresponding to data recorded on an optical disk, a stepping motor which includes a stator and a rotor, and excites the stator to rotate the rotor, thereby radially moving the optical pickup head over the optical disk, and a stopper which limits a range of movement of the optical pickup head when the optical pickup head is brought into contact with the stopper by the stepping motor, the method comprising: controlling, when the optical pickup head is brought into contact with the stopper and positioned at an initial position, the stepping motor by setting the stator at an electric angle corresponding to a rotation angle of the rotor assumed when the optical pickup head is in contact with the stopper.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the configuration of an optical disk apparatus according to an embodiment of the invention;

FIG. 2 is a flowchart useful in explaining the process of detecting correction data during an initial operation after power on;

FIG. 3 is a view illustrating changes in the rotational angles of the stator and rotor of the stepping motor 28, appearing in FIG. 1, powered by two-phase excitation;

FIG. 4 is a view illustrating the amount of rotation of the rotor acquired when the stator is excited to rotate the rotor by one rotation from the position of electric angle 1a;

FIG. 5 is a view illustrating the amount of rotation of the rotor acquired when the stator is excited to rotate the rotor by one rotation from the position of electric angle 2a;

FIG. 6 is a view illustrating the amount of rotation of the rotor acquired when the stator is excited to rotate the rotor by one rotation from the position of electric angle 3a; and

FIG. 7 is a view illustrating the amount of rotation of the rotor acquired when the stator is excited to rotate the rotor by one rotation from the position of electric angle 4a.

### DETAILED DESCRIPTION OF THE INVENTION

An embodiment of the invention will be described with reference to the accompanying drawings.

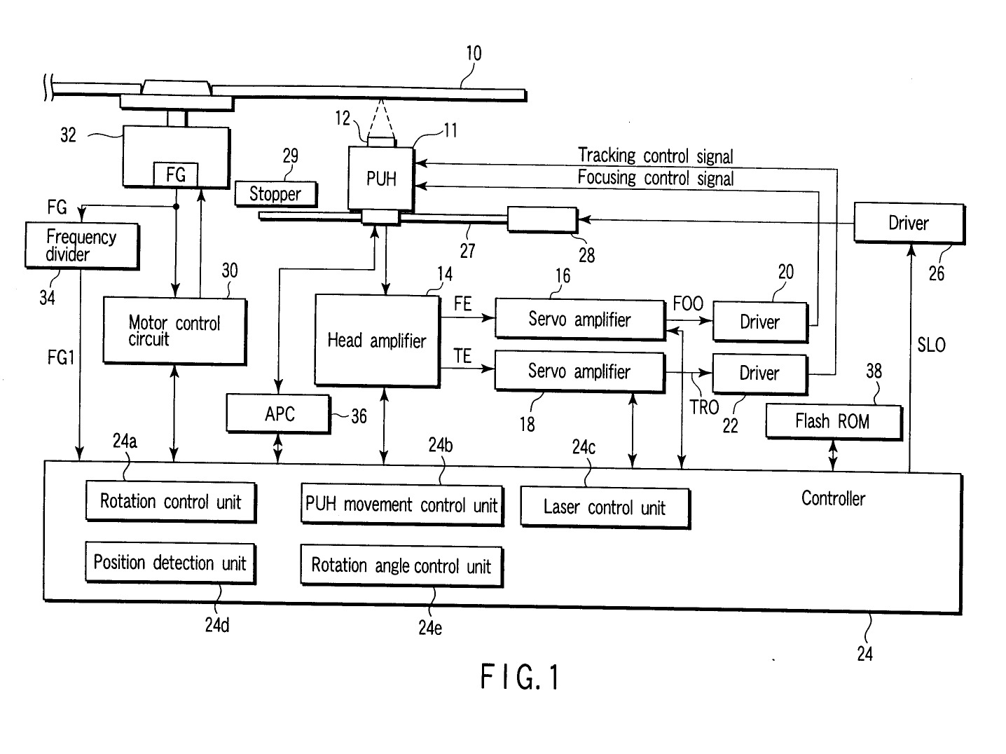

FIG. 1 is a block diagram illustrating the configuration of an optical disk apparatus according to the embodiment of the invention.

An optical disk 10 as a recording medium has a spiral track formed thereon, and is spun by a disk motor 32. The optical disk 10 in the embodiment is, for example, a compact disk (CD), digital versatile disk (DVD) or high-definition (HD) DVD, etc.

Recording/reading of data to/from the optical disk 10 is performed by a laser beam output from an optical pickup head (PUH) 11. The optical pickup head 11 is supported by a lead screw 27 so that it can move radially over the optical pickup head 11. When the stepping motor 28 is driven, the optical pickup head 11 is moved along the lead screw 27 to a position opposing the data reading surface of the optical disk 10. For instance, assume that the optical pickup head 11 is moved by 3 mm along the lead screw 27 each time the stepping motor 28 rotates by one rotation.

The optical pickup head 11 includes a laser diode, collimator lens, beam splitter, object lens 12, cylindrical lens, photodetector, lens position sensor and monitor diode, etc.

The optical pickup head 11 also includes a two-axle actuator for moving the object lens 12 in two directions perpendicular to each other. Namely, it includes a focusing actuator for moving the object lens 12 in a focusing direction (parallel to the optical axis of the lens) for focusing, and a tracking actuator for moving the object lens 12 in a tracking direction (the radial direction of the optical disk 10) for tracking. The focusing actuator is controlled by a focusing control signal output from a driver 20, while the tracking actuator is controlled by a tracking control signal output from a driver 22.

The laser diode is driven by an auto power control (APC) circuit 36 under the control of a controller 24 (laser control unit 24c), thereby outputting a laser beam. The laser beam output from the laser diode is converted on the optical disk 10 via the collimator lens, beam splitter and object lens 12.

The beam reflected from the optical disk 10 is guided to the photodetector via the object lens 12, beam splitter and cylindrical lens. The photodetector is, for example, a four-piece photodetector. The signal detected by the photodetector is output to a head amplifier 14.

The APC circuit 36 drives the laser diode under the control of the laser control unit 24c of the controller 24, to control the intensity levels of the laser beam upon turn on/off of the laser diode, and during reading/recording of data. The APC circuit 36 controls the amount of current to be output to the laser diode so that the output of a monitor diode (not shown) contained in the optical pickup head 11 is adjusted to a preset value.

The head amplifier 14 processes the signals output from the photodetector, thereby generating, for example, a tracking error signal TE indicating an error between the center of the beam spot of a laser beam, and the center of a target track, a focusing error signal FE indicating an error from the focus, and an RF signal (information signal) acquired by adding the signals output from the photodetector (e.g., a four-piece photodetector).

The focusing error signal FE and tracking error signal TE output from the head amplifier 14 are input to servo amplifiers 16 and 18, respectively.

The servo amplifier 16 controls the driver 20 in accordance with the focusing error signal FE output from the head amplifier 14. The driver 20, in turn, outputs a focusing control signal to a focusing actuator (not shown) incorporated in the optical pickup head 11.

Upon receiving the focusing control signal from the driver 20, the focusing actuator executes a focusing servo operation so that the laser beam output from the optical pickup head 11 will be focused on the recording film of the optical disk 10.

The servo amplifier 18 controls the driver 22 in accordance with the tracking error signal TE output from the heat amplifier 14. The driver 22, in turn, outputs a tracking control signal to a tracking actuator (not shown) incorporated in the optical pickup head 11.

Upon receiving the tracking control signal from the driver 22, the tracking actuator is driven to perform a tracking servo operation to cause the laser beam output from the optical pickup head 11 to always trace the track formed on the optical disk 10.

The disk motor 32 is, for example, a spindle motor. The disk motor 32 incorporates a frequency generator (FG) for generating a signal corresponding to the rotation angle of the motor. The frequency generator (FG) outputs FG signals corresponding to rotation angles of the motor, e.g., eighteen FG signals per one rotation, utilizing, for example, the voltage generated by the magnetic coil of the stator, or utilizing the output of a hole element that detects the rotation angle of the magnetic of the rotor.

A frequency divider 34 divides the frequency of the FG signal output from the disk motor 32, and outputs, to the controller 24, an FG1 signal indicating, for example, that the disk motor 32 has rotated by one rotation. The controller 24 compares the FG1 signal with the internal reference frequency signal, thereby controlling the motor control circuit 30 in accordance with the difference therebetween to thereby rotate the disk motor 32 at a preset rotational speed.

The controller 24 includes a processor and memories (such as RAM and ROM), and controls the entire system by executing various programs, stored in the memories, by the processor. The controller 24 includes a rotation control unit 24a, PUH movement control unit 24b, laser control unit 24c, position detection unit 24d and rotation angle control unit 24e.

The rotation control unit 24a controls the rotation of the disk motor 32 via the motor control circuit 30.

The PUH movement control unit 24b has the following three functions: Firstly, the PUH movement control unit 24b drives the stepping motor 28 via a driver 26 to radially move the optical pickup head 11 over the optical disk 10. Secondly, in order to set the initial position of the optical pickup head 11, the PUH movement control unit 24b radially inwardly moves the optical pickup head 11 over the optical disk 10 to bring the optical pickup head 11 into contact with a stopper 29 that defines the movable range of the optical pickup head 11. Thirdly, the PUH movement control unit 24b controls the position of the optical pickup head 11, using, as the initial position, the position of the optical pickup head 11 assumed when it is in contact with the stopper 29.

The stopper 29 is provided at a preset location in the optical disk apparatus. Since the stopper 29 have a dimension error and/or attachment error, variations occur in the position of the optical pickup head 11 when the optical pickup head 11 is brought into contact with the stopper 29 of different optical disk apparatuses. In the optical disk apparatus of the embodiment, to position the optical pickup head 11 at high precision, the step-out of the stepping motor 28 is corrected based on correction data preset by the controller 24. The correction data indicates the rotation angle of the rotor of the stepping motor 28 assumed when the optical pickup head 11 is brought into contact with the stopper 29.

The laser control unit 24c controls the APC circuit 36 to cause the laser diode of the optical pickup head 11 to output a laser beam.

The position detection unit 24d detects the position of the optical pickup head 11 moved by the stepping motor 28 during the initial operation performed upon power on. In the embodiment, a disk address (address information) recorded on the optical disk 10 is detected based on the signal detected by the optical pickup head 11 on the optical disk 10. From the disk address, the position of the optical pickup head 11 is determined.

The rotation angle control unit 24e controls the driver 26 to stop the excitation of the stator of the stepping motor 28 at a preset electric angle, after the optical pickup head 11 is brought into contact with the stepper 29.

The rotor of the stepping motor 28 is formed of a magnet. The PUH movement control unit 24b controls the stepping motor 28 via the driver 26, utilizing, for example, a two-phase excitation scheme.

A flash ROM 38 is a nonvolatile memory for storing various types of data. In the invention, the flash ROM 38 stores correction data for correcting the step-out of the stepping motor 28 that occurs during initialization performed upon power on.

The operation of the optical disk apparatus according to the embodiment will now be described.

The optical disk apparatus of the embodiment does not employ a mechanical switch for detecting the initial position of the optical pickup head 11. Instead, in the optical disk apparatus of the embodiment, during initialization upon power on, the optical pickup head 11 is radially inwardly moved over the optical disk 10 to be brought into contact with the stopper 29, and this position is set as the initial position of the optical pickup head 11. Further, in the embodiment, the rotation angle of the rotor of the stepping motor 28, which is assumed when the optical pickup head 11 is in contact with the stopper 29, is corrected based on the correction data acquired by pre-learning and stored in the flash ROM 38, and the rotor is stopped at the corrected rotation angle.

In the learning process of the correction data, for facilitating the description, suppose that an operation is iterated four times, in which excitation of the stator of the stepping motor 28 is stopped at each of preset electric angles, and then the stepping motor 28 is again excited to move the optical pickup head 11 in the radially outward direction (FW) by the distance corresponding to a preset rotation amount of the rotor of the stepping motor 28. Namely, the whole electric angle (360 degrees) of the stator is divided into, for example, four angles, and the four distances, over which the optical pickup head 11 is moved from the positions corresponding to the respective angles, are acquired. After that, the average value of the acquired distances is computed, and correction data is acquired based on the computed average value.

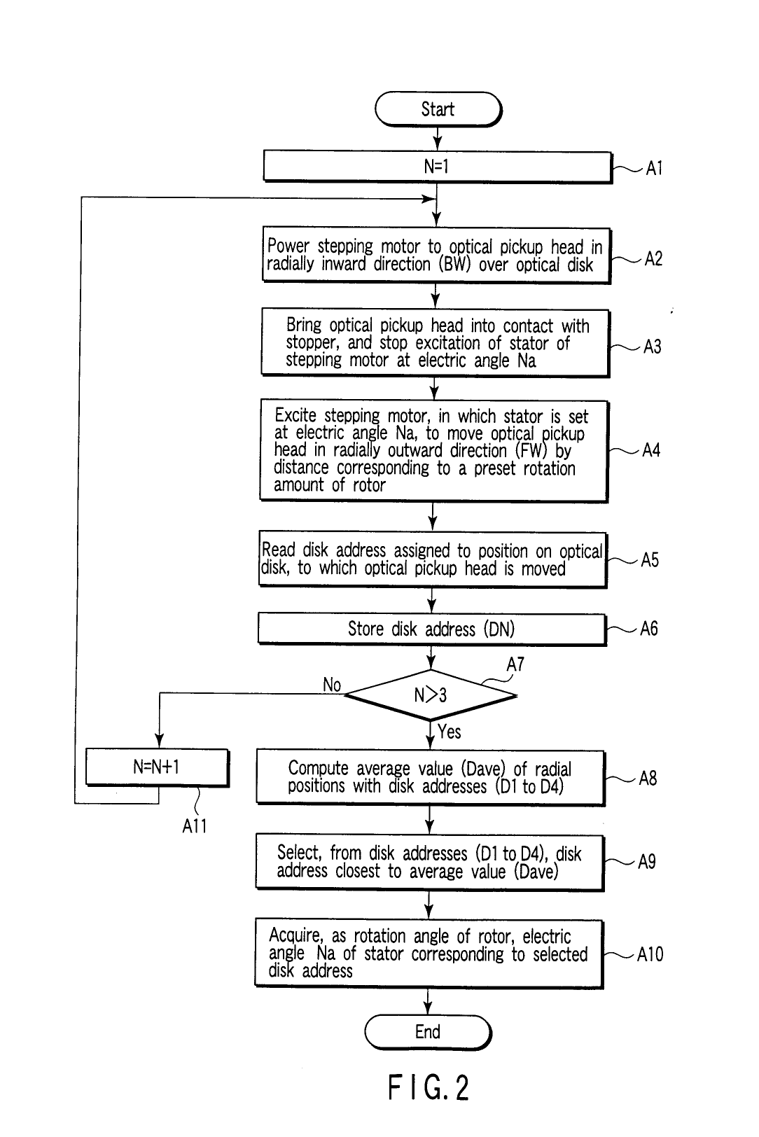

Referring now to the flowchart of FIG. 2, a description will be given of the method of acquiring the rotation angle of the rotor of the stepping motor 28 during initialization upon power on, and the process of acquiring correction data for the rotation angle of the rotor based on the rotation angle acquired during initialization.

Upon power on, the optical disk apparatus detects whether the optical disk 10 is loaded. If no optical disk 10 is loaded, the loading of the optical disk 10 is induced. For instance, a tray for placing the optical disk 10 thereon is ejected. Alternatively, a message is displayed or a voice message is output for inducing a user to load the optical disk 10. The optical disk 10 records disk addresses that indicate absolute positions thereon. Based on each disk address read from the optical disk 10, the corresponding radial position on the optical disk 10 can be computed.

When the optical disk 10 is loaded, the controller 24 sets, to an initial value of “1 ”, variable N that indicates the number of operations for radially outwardly moving the optical pickup head 11 after bringing it into contact with the stopper 29 (step A1).

Subsequently, the PUH movement control unit 24b of the controller 24 drives the stepping motor 28 to move the optical pickup head 11 over the optical disk 10 by a preset distance in the radially inward direction (BW) (step A2). Namely, the PUH movement control unit 24b supplies, to the stepping motor 28 via the driver 26, a greater number of pulses than that required for bringing the optical pickup head 11 into contact with the stopper 29.

This process is performed for the following reason: Upon power on, the controller 24 does not recognize at which position the optical pickup head 11 is positioned on the optical disk 10. Accordingly, when the optical pickup head 11 is moved for the first time after power on (N=1), pulses that enable the optical pickup head 11 to be brought into contact with the stopper 29 even if the optical pickup head 11 is positioned at the radially outermost position are supplied to the stepping motor 28 to radially inwardly move the optical pickup head 11. As a result, after the optical pickup head 11 contacts the stopper 29 and hence the rotor of the stepping motor 28 is stopped, the stator and rotor of the stepping motor 28 become out of step with each other. The rotation angle control unit 24e stops excitation of the stator of the stepping motor 28 at electric angle Na (step A3).

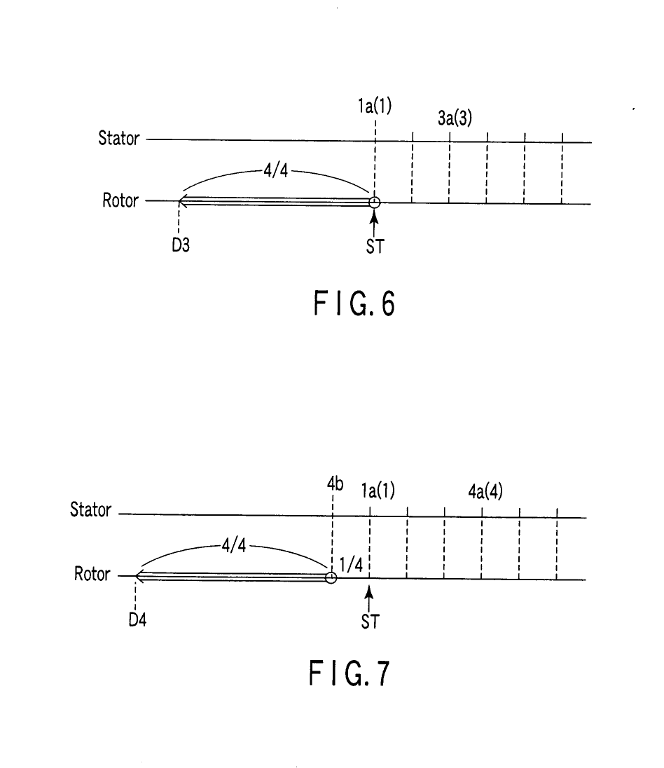

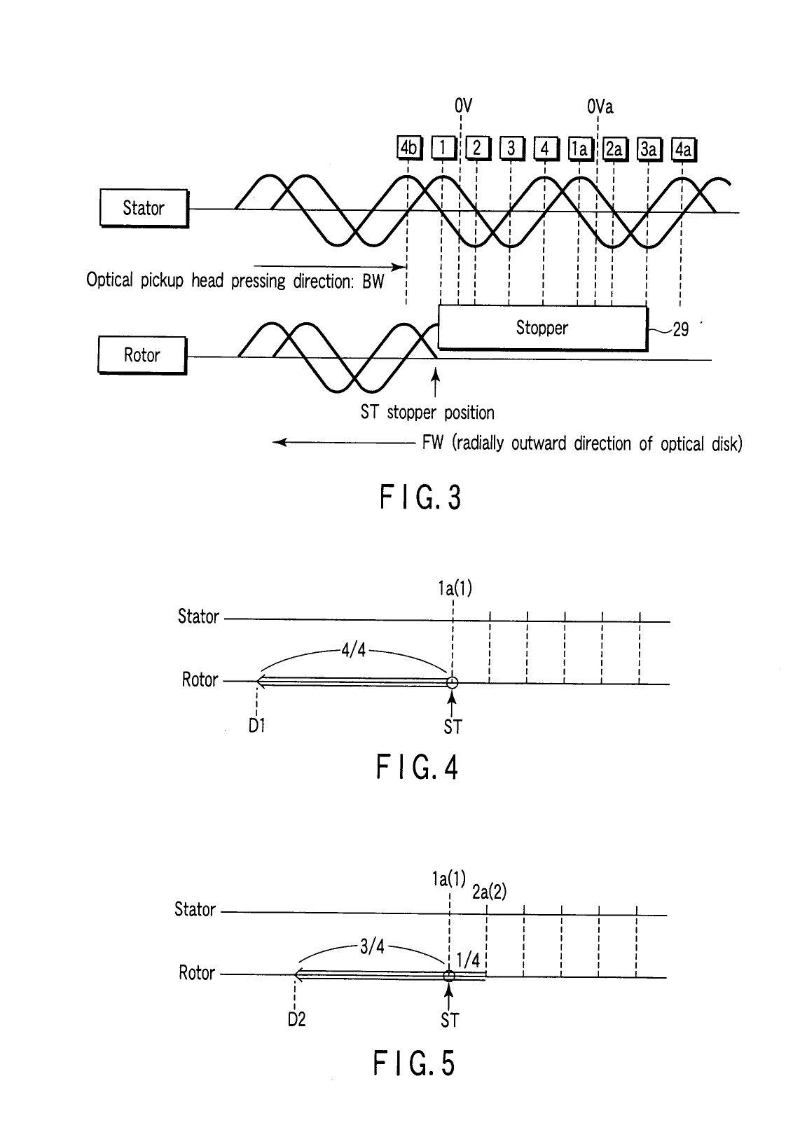

FIG. 3 shows changes in the electric angle and rotation angle of the stator and rotor of the stepping motor 28 powered by, for example, two-phase excitation, respectively. In FIG. 3, 1 to 4, 1a to 4a and 4b indicate electric angles of the stator. In FIG. 3, 1 and 1a denote the same angle. Similarly, 2 and 2a denote the same angle. 3 and 3a denote the same angle. 4 and 4a denote the same angle.

When the optical pickup head 11 is moved in the radially inward direction (BW) in accordance with the operation of the stepping motor 28, it is brought into contact with the stopper 29. At this time, assume that the rotation of the rotor of the stepping motor 28 is stopped at stopper position ST, e.g., rotation angle 1. However, even if the rotor of the stepping motor 28 is stopped, the PUH movement control unit 24b of the controller 24 cannot detect it, therefore continues excitation of the stator even after the optical pickup head 11 contacts the stopper 29. Accordingly, the stepping motor 28 operates with the rotor and stator kept out of step. The PUH movement control unit 24b stops the stator at, for example, electric angle 1a.

FIG. 3 shows a case where the excitation of the stator is stopped at electric angles 1a, 2a, 3a and 4a, after the optical pickup head 11 contacts the stopper 29 and the rotation of the rotor is stopped. Actually, however, the stator is excited for a longer time to enable the optical pickup head 11 to more reliably contact the stopper 29.

After that, the PUH movement control unit 24b drives the stepping motor 28 in which the stator assumes electric angle 1a, thereby moving the optical pickup head 11 in the radially outward direction (FW) (step A4). At this time, the PUH movement control unit 24b excites the stator for the time corresponding to a preset amount of rotation of the rotor.

For instance, in FIG. 3, the electric angle of the stator corresponding to the position ST of the stopper 29 for stopping the rotation of the rotor is 1 or 1a. Accordingly, when the excitation of the stator is stopped at electric angle 1a, the rotor is positioned at the position corresponding to the electric angle 1a of the stator. Therefore, when the stator of electric angle 1a(1) is excited for the time corresponding to the preset rotation amount of the rotor, the rotor is rotated in accordance with the excitation, thereby moving the optical pickup head 11 in the radially outward direction (FW) (step A4).

The controller 24 performs control for causing the optical pickup head 11 radially outwardly moved by the distance corresponding to the preset rotation amount of the rotor, to read a disk address recorded on the optical disk 10 (step A5). Namely, the laser control unit 24c drives the APC circuit 36 to cause the optical pickup head 11 to emit a preset laser beam to the optical disk 10, and the rotation control unit 24a controls the motor control circuit 30 to rotate the optical disk 10 at a preset rotational speed. After that, the controller 24 causes the laser beam from the optical pickup head 11 to be focused on the optical disk 10, and starts a tracking servo operation.

The light reflected from the optical disk 10 is guided to the photodetector incorporated in the optical pickup head 11. The photodetector, in turn, outputs, to the head amplifier 14, a signal indicating the intensity of the light. Based on the signals output from the photodetector, the head amplifier 14 generates an RF signal, tracking error signal TE and focusing error signal FE. In accordance with the focusing error signal FE, a focus control signal is output from the driver 20 to the optical pickup head 11, thereby executing focusing servo control. In accordance with the tracking error signal TE, a tracking control signal is output from the driver 22 to the optical pickup head 11, thereby executing tracking servo control.

The RF signal output from the head amplifier 14 is demodulated by a reproduction circuit (not shown), thereby generating the disk address (D1) recorded on the optical disk 10. The position detection unit 24d of the controller 24 stores the disk address (D1) in the internal memory (step A6).

A description will be given of four cases where the optical pickup head 11 is brought into contact with the stopper 29, and the rotor and stator of the stepping motor 28 become out of step with each other.

FIG. 4 shows the actual amount of rotation (amount of angular movement) of the rotor caused when the stator of electric angle 1a is excited during the time corresponding to the number of pulses generated when the rotor in the free state is rotated by a preset rotation amount. In FIGS. 4 to 7, for facilitating the description, suppose that the preset rotation amount of the rotor is one rotation, and that the optical pickup head 11 is radially outwardly moved in accordance with the rotation of the rotor. Actually, however, the preset rotation amount is the amount of rotation for moving the optical pickup head 11 to a position at which the head can read the disk address D1 recorded on the optical disk 10.

For instance, when the stator of electric angle 1a is excited by the PUH movement control unit 24b to rotate the rotor by one rotation (4/4 of one rotation), the rotor is rotated by one (4/4) rotation in accordance with the excitation of the stator. The address read by the optical pickup head 11 at the position on the optical disk 10, to which the optical pickup head 11 is moved in accordance with the rotation of the rotor, is set to D1.

If N>3 (No at step A7), the controller 24 adds +1 to variable N (step A11), and then re-executes steps A2 to A6. Namely, the PUH movement control unit 24b of the controller 24 drives the stepping motor 28 to bring the optical pickup head 11 into contact with the stopper 29. In this case, the PUH movement control unit 24b stops the rotor at the angular position corresponding to electric angle 2a of the stator.

Thus, when the rotation angle of the rotor reaches 1a(1), the optical pickup head 11 contacts the stopper 29, and the excitation of the stator is stopped at electric angle 2a(2). At this time, if the PUH movement control unit 24b excites the state of electric angle 2a(2), the optical pickup head 11 is moved over the optical disk 10 in the radially outward direction (FW) through the distance corresponding to one rotation of the rotor.

FIG. 5 shows the actual rotation amount of the rotor caused when the stator of electric angle 2a is excited during the time corresponding to the number of pulses generated when the rotor in the free state is rotated by one rotation.

As shown in FIG. 5, when the stator of electric angle 2a is excited to rotate the rotor by one (4/4) rotation, the torque of the rotor is absorbed by the stator and hence does not rotate during the time when the stator assumes an electric angle ranging from 2a to la (corresponding to ¼ of one rotation). At this time, the torque of the rotor serves to urge the optical pickup head 11 against the stopper 29. After the electric angle of the stator reaches electric angle la, the rotation angle of the rotor becomes to correspond to the electric angle of the stator, and hence the rotor is rotated in accordance with the excitation of the stator after electric angle 1a. Suppose that D2 is the disk address read by the optical pickup head 11 from the optical disk 10 when the optical pickup head 11 is moved through the distance corresponding to ¾ of one rotation of the rotor.

In the case of FIG. 5, when the stator is excited during the time corresponding to the number of pulses generated when the rotor in the free state is rotated by one (4/4) rotation, the rotor is rotated by only ¾ of one rotation. This means that when the stator assumes the electric angle ranging from 2a to 1a, the optical pickup head 11 is not moved. Accordingly, the movement distance of the optical pickup head 11 is shorter by the distance (i.e., ¼ of one rotation) corresponding to electric angle ranging from 2a to 1a.

Similarly, if N>3 (No at step A7), the controller 24 adds +1 to variable N (step A11), and then re-executes steps A2 to A6. Namely, the controller 24 drives the stepping motor 28 to bring the optical pickup head 11 into contact with the stopper 29. In this case, the controller 24 stops the rotor at the angular position corresponding to electric angle 3a of the stator.

In this case, suppose that the rotation angle of the rotor assumed when the optical pickup head 11 is brought into contact with the stopper 29 and the rotor is stopped corresponds to 1a(1). Since the rotor is stopped at the angular position corresponding to electric angle 3a(3) of the stator, it assumes a neutral state. Namely, when the rotor is stopped at the angular position corresponding to electric angle 3a(3) of the stator, the optical pickup head 11 is in appropriate contact with the stopper 29. After that, when the PUH movement control unit 24b excites the stator of electric angle 3(3), the optical pickup head 11 is moved in the radially outward direction (FW) by the distance corresponding to one rotation of the rotor.

FIG. 6 shows the rotation amount of the rotor assumed when the stator of electric angle 3a is excited during the time corresponding to the number of pulses generated when the rotor in the free state is rotated by one rotation.

As shown in FIG. 6, when the stator of electric angle 3a is excited to rotate the rotor by one (4/4) rotation, the rotor is rotated by one (4/4) rotation in accordance with the excitation. Suppose here that D3 is the disk address read by the optical pickup head 11 from the optical disk 10 when the optical pickup head 11 is moved through the distance corresponding to 4/4 of one rotation of the rotor. Disk address D3 is identical to disk address D1.

Similarly, if N>3 (No at step A7), the controller 24 adds +1 to variable N (step A11), and then re-executes steps A2 to A6. Namely, the controller 24 drives the stepping motor 28 to bring the optical pickup head 11 into contact with the stopper 29. In this case, the controller 24 stops the rotor at the angular position corresponding to electric angle 4a of the stator.

In this case, suppose that the rotation angle of the rotor assumed when the optical pickup head 11 is brought into contact with the stopper 29 and the rotor is stopped corresponds to 1a(1). On the other hand, the excitation of the stator is stopped at electric angle 4a(4). At this time, the rotor is rotated to the angular position corresponding to electric angle 4a of the stator, and stopped at rotation angle 4b that is equal to electric angle 4a. Namely, the optical pickup head 11 is stopped at the position on the disk radially outwardly away from the stopper position ST by the distance corresponding to ¼ of one rotation of the rotor. At this time, if the PUH movement control unit 24b excites the stator of electric angle 4a(4b), the optical pickup head 11 is moved over the optical disk 10 in the radially outward direction (FW) by the distance corresponding to one rotation of the rotor.

FIG. 7 shows the rotation amount of the rotor assumed when the stator of electric angle 4a(4b) is excited during the time corresponding to the number of pulses generated when the rotor in the free state is rotated by one rotation.

As shown in FIG. 7, when the stator of electric angle 4a(4b) is excited to rotate the rotor by one (4/4) rotation, the rotor is rotated by 5/4 of one rotation in accordance with the excitation since the optical pickup head 11 is stopped at the position on the disk radially outwardly away from the stopper position ST by ¼ of one rotation. Suppose that D4 is the disk address read by the optical pickup head 11 from the optical disk 10 when the optical pickup head 11 is moved through the distance corresponding to 5/4 of one rotation of the rotor.

Since N=4, i.e., N>3, (Yes at step A7), the controller 24 executes step A8. Thus, the process of bringing the optical pickup head 11 into contact with the stopper 29, then stopping the stator of the stepping motor 28 at a preset electric angle, and reading the disk address of the position, to which the optical pickup head 11 is radially outwardly moved by the stepping motor 28 by a preset distance, is iterated four times, thereby acquiring disk addresses D1 to D4.

After that, the controller 24 computes the average value Dave of radial positions with the acquired disk addresses D1 to D4 (step A8).

Subsequently, the controller 24 selects, from D1 to D4, the disk address closest to the average value Dave (step A9). The controller 24 determines the electric angle Na of the stator corresponding to the selected disk address, uses the determined angle as the rotation angle of the rotor assumed when the optical pickup head 11 is brought into contact with the stopper 29 (step A10), and stores the rotation angle Na of the rotor in the flash ROM 38.

Specifically, when the stator of electric angle 1a(1) or 3a(3) is excited during the time corresponding to the number of pulses generated when the rotor in the free state is rotated by one rotation, in order to radially outwardly move the optical pickup head 11 over the optical disk 10, the optical pickup head 11 is moved to substantially the same position (see FIGS. 4 and 6). At this time, the disk addresses read from the optical disk 10 are D1 and D3. Further, when the stator of electric angle 2a(2) is excited during the time equal to the above, the optical pickup head 11 is moved to the position corresponding to ¾ of one rotation of the rotor (see FIG. 5). At this time, the disk address read from the optical disk 10 is D2. When the stator of electric angle 4a(4b) is excited during the time equal to the above, the optical pickup head 11 is moved to the position corresponding to 5/4 of one rotation of the rotor (see FIG. 7).

Accordingly, the average Dave of the radial positions corresponding to disk addresses D1 to D4 is determined to be closest to disk address D1 (D3).

Which one of disk addresses D1 and D3 is selected can be determined in the following way. For instance, it is determined whether disk address D2 read after disk address D1 is the address read from a radially more inner portion of the optical disk 10 than disk address D1. Similarly, it is determined whether disk address D4 read after disk address D3 is the address read from a radially more inner portion of the optical disk 10 than disk address D3. If the afterwards read disk address is read from a radially more inner portion of the optical disk 10, it is selected.

In the example shown in FIGS. 4 to 7, disk address D2 read immediately after disk address D1 is read from a radially more inner portion of the optical disk 10. In contrast, disk address D4 read immediately after disk address D3 is read from a radially more outer portion of the optical disk 10. Accordingly, disk address D1 is selected. As shown in FIG. 5, the fact that disk address D2 read immediately after disk address D1 is read from the radially more inner portion of the optical disk 10 indicates that the optical pickup head 11 is pressed against the stopper 29. Therefore, it can be determined that the electric angle 1a(1) of the stator assumed when disk address D1 is read corresponds to the rotation angle of the rotor assumed when the optical pickup head 11 is in contact with the stopper 29. The controller 24 stores the rotation angle 1a of the rotor in the flash ROM 38.

The rotation angle 1a of the rotor stored in the flash ROM 38 is read by the controller 24, and is used as correction data for correcting the set-out state of the stepping motor 28 that occurs when the optical pickup head 11 contacts the stopper 29 during the operation of setting the optical pickup head 11 to the initial position. This enables the optical pickup head 11 to be correctly positioned.

More specifically, control data, for example, is recorded at a preset position on the optical disk 10. When the optical disk 10 is a CD, table-of-content (TOC) data is recorded at a preset position on the disk, while when the optical disk 10 is a DVD or HD-DVD, lead-in information is recorded at a preset position on the disk. In general, in the controller 24, the distance between the initial position on the disk defined by the stopper 29 and the position on the disk at which each of the above-mentioned data items is set. Accordingly, the controller 24 can move the optical pickup head 11 to the control data recorded position in a short time, after bringing the optical pickup head 11 into contact with the stopper 29 to detect the initial position. Actually, however, stoppers 29 have dimension errors and/or attachment errors, and hence the initial position of the optical pickup head 11 detected when the optical pickup head 11 contacts the stopper 29 contains an error because of such a dimension/attachment error. In the embodiment, the controller 24 corrects the step-out state of the stepping motor 28 caused by the initial position error, based on the correction data stored in the flash ROM 38.

As described above, in the optical disk apparatus of the embodiment, the rotation angle of the rotor of the stepping motor 28 assumed when the optical pickup head 11 is in contact with the stopper 29 can be detected, thereby correcting the position of the optical pickup head 11 using the rotation angle as correction data. Accordingly, even if variations in the initial position of the optical pickup head 11 defined by the stopper occur between different optical disk apparatuses because of stopper dimension/attachment errors, the positioning of the optical pickup head 11 can be controlled with high accuracy. In particular, even if the pitch of tracks for data recording is small as in a high-density recording medium such as an HD-DVD, correction can be performed on a stepping motor rotation angle basis, with the result that accurate data reading can be realized.

It is possible to employ, as a method for detecting whether the optical pickup head 11 is brought into contact with the stopper 29, a method for detecting whether the back electromotive voltage of the stepping motor 28 is reduced or reaches 0(V). For instance, the back electromotive voltage can be detected by providing the time for powering the stepping motor 28, and the time for stopping the powering of the stepping motor 28 to measure the back electromotive voltage. In this case, the supply of power to the stepping motor 28 is stopped during the time corresponding to a certain electric angle range of the stator, and the back electromotive voltage of the stepping motor is measured during that time. In this method, however, the optical pickup head 11 may not always be in contact with the stopper 29 during the time when the back electromotive voltage is measured. Further, since time delay occurs in the detection of the back electromotive voltage, an error will occur between the time when it is detected that the back electromotive voltage reaches 0(V), and the time when the rotor contacts the stopper 29 and hence stops its rotation. This being so, the method of detecting that the optical pickup head 11 is brought into contact with the stopper, based on a change in the back electromotive voltage cannot provide accurate correction data.

In contrast, in the optical disk apparatus of the embodiment, the whole electric angle (360 degrees) of the stator is divided into a plurality of electric angles, and the rotor is rotated through a preset angle from the position corresponding to each of the electric angles, thereby radially outwardly moving the optical pickup head 11 over the optical disk 10. Based on the average of the movements of the optical pickup head 11, the rotation angle of the rotor assumed when the optical pickup head 11 contacts the stopper 29 is detected. As a result, the rotation angle of the rotor assumed when the optical pickup head 11 contacts the stopper 29 can be detected accurately.

Although in the above description, the whole electric angle (360 degrees) of the stator is divided into four, and the operation of radially outwardly moving the optical pickup head 11 over the optical head 10 is iterated four times, the number of divisions may be increased, and the number of operations of radially outwardly moving the optical pickup head 11 may be increased. Further, instead of performing the operation of radially outwardly moving the optical pickup head 11 only one time for each electric angle of the stator, the operation may be iterated several times for each electric angle of the stator. This enables the rotation angle of the rotor to be detected more accurately when the optical pickup head 11 is in contact with the stopper 29.

Furthermore, correction data for correcting the position of the optical pickup head 11 may be detected whenever the initial operation is performed upon power on of the optical disk apparatus. Alternatively, it may be detected only one time during the initial operation performed when the optical disk apparatus is powered on for the first time. The first power on of the apparatus may be performed in a factory before it is shipped, or when a user uses the apparatus for the first time. The correction data detected upon the first power on is stored in the flash ROM 38 (learning process). When correction data is stored in the flash ROM 38, the controller 24 of the optical disk apparatus does not perform the operation of detecting correction data during the initial operation, and reads correction data from the flash ROM 38 to use it for controlling the positioning of the optical pickup head 11. Alternatively, the optical disk apparatus may detect correction data and store it in the flash ROM 38 in accordance with an externally input instruction. In this case, the apparatus can modify the correction data in accordance with, for example, an instruction from a user.

Although in the above description, the optical disk 10 is a standard disk from which data is read, it may be used as a dedicated reference disk for detecting correction data. For example, a reference disk is used when the optical disk apparatus is powered on for the first time. Assume that the reference disk records, for example, disk address data arranged in the radial direction of the disk.

Also, in the embodiment, the position of the optical pickup head 11 assumed when the optical pickup head 11 is moved in the radially outward direction (FW) is detected by reading address information recorded on the optical disk 10. However, the distance over which the optical pickup head 11 is moved may be measured by another method. The distance may be measured by, for example, a photodetector.

Moreover, in the embodiment, the stopper 29 is provided close to the inner periphery of the optical disk 10, and the optical pickup head 11 is moved in the radially inward direction (BW) and brought into contact with the stopper 29. However, the stopper 29 may be provided close to the outer periphery of the optical disk 10. In this case, to detect the initial position of the optical pickup head 11 during the initial operation, the optical pickup head 11 is moved in the radially outward direction and brought into contact with the stopper 29.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk apparatus comprising:
An optical pickup head which detects a signal corresponding to data recorded on an optical disk;
a stepping motor which includes a stator and a rotor, and excites the stator to rotate the rotor, thereby radially moving the optical pickup head over the optical disk;
a stopper which limits a range of movement of the optical pickup head when the optical pickup head is brought into contact with the stopper by the stepping motor; and
a controller which controls, when the optical pickup head is brought into contact with the stopper and positioned at an initial position, the stepping motor by setting the stator at an electric angle corresponding to a rotation angle of the rotor assumed when the pickup head is in contact with the stopper.

2. The optical disk apparatus according to claim 1, wherein the electric angle set by the controller is selected from a plurality of electric angles, into which a whole electric angle of 360° of the stator is divided, the selected electric angle providing an appropriate control result.

3. The optical disk apparatus according to claim 1, wherein the controller performs:
(1) exciting the stepping motor to move the optical pickup head over a preset distance in a first direction in which the stopper is provided;
(2) stopping excitation of the stepping motor when the stator assumes a preset electric angle, after the optical pickup head is brought into contact with the stopper and the rotor is out of step with the stator;
(3) re-exciting the stepping motor, stopped at the preset electric angle, to move the optical pickup head over a distance corresponding to a preset rotation amount of the stepping motor in a second direction opposite to the first direction;
(4) reading a disk address assigned to a position on the optical disk, the optical pickup head being moved to the position over the distance corresponding to the preset rotation amount;
(5) iterating the above operations (1) to (4) for each of N electric angles, into which a whole electric angle of 360° of the stator is divided, and computing an average value of position information indicated by disk addresses read during iterating the above operations (1) to (4); and
(6) storing one of the N electric angles as correction data indicating a rotation angle of the rotor, the one electric angle providing position information closest to the average value.

4. The optical disk apparatus according to claim 3, further comprising a nonvolatile memory which stores the correction data, and wherein the controller corrects a rotational angle of the rotor assumed when the optical pickup head is in contact with the stopper, based on the correction data stored in the nonvolatile memory.

5. An optical pickup head positioning method for use in an optical disk apparatus including an optical pickup head which detects a signal corresponding to data recorded on an optical disk, a stepping motor which includes a stator and a rotor, and excites the stator to rotate the rotor, thereby radially moving the optical pickup head over the optical disk, and a stopper which limits a range of movement of the optical pickup head when the optical pickup head is brought into contact with the stopper by the stepping motor, the method comprising:
controlling, when the optical pickup head is brought into contact with the stopper and positioned at an initial position, the stepping motor by setting the stator at an electric angle corresponding to a rotation angle of the rotor assumed when the optical pickup head is in contact with the stopper.

6. The optical pickup head positioning method according to claim 5, wherein the controlling the stepping motor includes:
(1) exciting the stepping motor to move the optical pickup head over a preset distance in a first direction in which the stopper is provided;
(2) stopping excitation of the stepping motor when the stator assumes a preset electric angle, after the optical pickup head is brought into contact with the stopper and the rotor is out of step with the stator;
(3) re-exciting the stepping motor, stopped at the preset electric angle, to move the optical pickup head over a distance corresponding to a preset rotation amount of the stepping motor in a second direction opposite to the first direction;
(4) reading a disk address assigned to a position on the optical disk, the optical pickup head being moved to the position over the distance corresponding to the preset rotation amount;
(5) iterating the above operations (1) to (4) for each of N electric angles, into which a whole electric angle of 360° of the stator is divided, and computing an average value of position information indicated by disk addresses read during iterating the above operations (1) to (4); and
(6) setting one of the N electric angles which provides position information closest to the average value.
